(19) United States
(12) Patent Application Publication
(10) Pub. No.: US 2024/0344625 A1
(43) Pub. Date: Oct. 17, 2024

(54) ADJUSTABLE CHECK VALVE

(71) Applicant: Republic Oil Tools, LLC, Oklahoma City, OK (US)

(72) Inventors: Joshua Prather, Millsap, TX (US); Robert Hicks, Oklahoma City, OK (US)

(21) Appl. No.: 18/632,447

(22) Filed: Apr. 11, 2024

Related U.S. Application Data
(60) Provisional application No. 63/458,813, filed on Apr. 12, 2023.

(51) Int. Cl. F16K 17/06; E21B 34/08; F16K 15/04

(52) U.S. Cl. CPC F16K 17/06; F16K 15/044; E21B 34/08

(57) ABSTRACT

An adjustable check valve that can include a housing with an inlet and an outlet and a sleeve slidably disposed in the housing, the sleeve having a ball holder portion with a first ball disposed therein. The adjustable check valve can also include a first spring disposed in a lower spring chamber that engages the sleeve to force the first ball into a first seat to prevent fluid from flowing uphole in the adjustable check valve and a set screw threadably engaged with the housing to apply a desired amount of tension to the first spring. A method of designing an adjustable check valve to have a desired crack pressure. The method includes the step of determining a desired crack pressure of the adjustable check valve based on operational parameters. The method also includes the step of assembling the adjustable check valve to have the desired crack pressure.

### CROSS-REFERENCE TO RELATED APPLICATIONS

The present application is a conversion of U.S. Provisional Application having U.S. Ser. No. 63/458,813, filed Apr. 12, 2023, which claims the benefit under 35 U.S.C. 119(e). The disclosure of which is hereby expressly incorporated herein by reference.

### BACKGROUND OF THE DISCLOSURE

### 1. Field of the Invention

The present disclosure relates to an adjustable check valve for permitting fluids above a desired pressure, which can be adjusted, to flow in only a downhole direction through a bottom hole assembly.

### 2. Description of the Related Art

Check valves are used in numerous downhole oil and gas applications and typically have a single operational fluid pressure (i.e., each check valve can only have a single cracking pressure). The cracking pressure is the required pressure of the fluid for the fluid to be able to flow through the check valve.

Accordingly, there is a need for an adjustable check valve that can provide an operator with the ability to adjust the cracking pressure of a check valve to fit different operational parameters.

### SUMMARY OF THE DISCLOSURE

The present disclosure is directed to an adjustable check valve. The adjustable check valve can include a housing with an inlet and an outlet and a sleeve slidably disposed in the housing, the sleeve having a ball holder portion with a first ball disposed therein. The adjustable check valve can also include a first spring disposed in a lower spring chamber that engages the sleeve to force the first ball into a first seat to prevent fluid from flowing uphole in the adjustable check valve and a set screw threadably engaged with the housing to apply a desired amount of tension to the first spring.

The present disclosure can also be directed to a method of designing an adjustable check valve to have a desired crack pressure. The method includes the step of determining a desired crack pressure of the adjustable check valve based on operational parameters. The method also includes the step of assembling the adjustable check valve to have the desired crack pressure.

### BRIEF DESCRIPTION OF THE DRAWINGS

FIG. 1 is a cross-sectional view of an adjustable check valve constructed in accordance with the present disclosure.

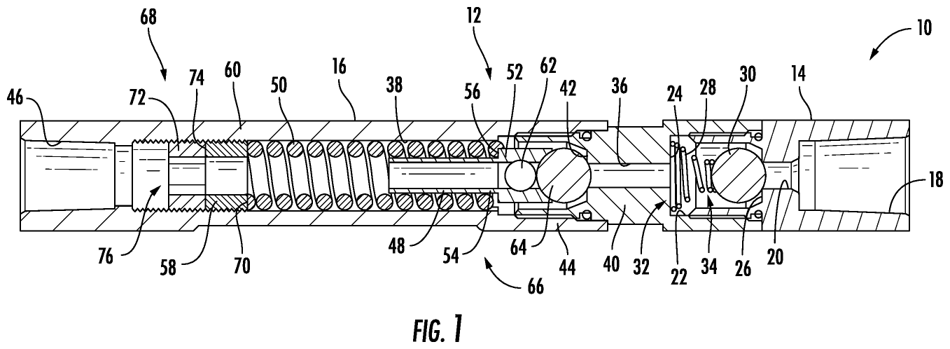

FIG. 2 is an exploded view of the adjustable check valve constructed in accordance with the present disclosure.

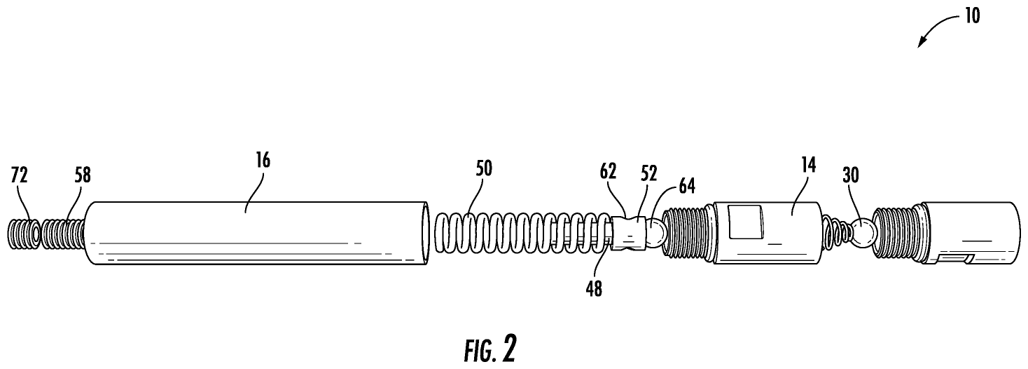

### DETAILED DESCRIPTION OF THE DISCLOSURE

The present disclosure relates to an adjustable check valve 10 that can be manipulated by a user to have a different cracking pressure (i.e., the pressure fluid has to be at to be able to flow through the adjustable check valve 10). The adjustable check valve 10 is designed such that fluid can only flow through the adjustable check valve 10 in a downhole direction and fluid is prevented from flowing uphole through the adjustable check valve 10.

The adjustable check valve 10 can include a housing 12 for containment of the operational components of the adjustable check valve 10. The housing 12 can be made up of various parts that can be combined to create the housing 12. The housing 12 can include an upper spring housing 14 and a spring valve housing 16. The upper spring housing 14 includes an inlet 18 for the adjustable check valve 10 and a first passageway 20 that fluidically connects the inlet 18 and an upper spring chamber 22. The upper spring chamber 22 can be located between a shoulder 24 and a first ball seat 26. The adjustable check valve 10 can include a first spring 28 and a first fluid blocking member 30 disposed in the upper spring chamber 22. The first spring 28 is positioned between the shoulder 24 and the first fluid blocking member 30 and forces the first fluid blocking member 30 in the uphole direction against the first ball seat 26 to prevent fluids from flowing uphole through the adjustable check valve 10. In one embodiment, the first spring 28 can be conically shaped such that a larger diameter 32 portion engages the shoulder 24 and a smaller diameter portion 34 engages the first fluid blocking member 30. The first fluid blocking member 30 can have any shape such that it can engage the first seat 26 and prevent fluid from flowing uphole through the adjustable check valve 10. In one exemplary embodiment, the first fluid blocking member 30 can be a ball.

The upper spring housing 14 of the adjustable check valve 10 can include a second passageway 36 that fluidically connects the upper spring chamber 22 to a lower spring chamber 38. The second passageway 36 extends from the shoulder 24 in the upper spring housing 14, through a body portion 40 of the upper spring housing 14 to a second seat 42 disposed on an uphole end 44 of the lower spring chamber 38. The lower spring chamber 38 extends from the second seat 42 to an outlet 46 of the adjustable check valve 10. A sleeve 48 and a second spring 50 can be positioned in the lower spring chamber 38. The sleeve 48 is slidably disposed in the lower spring chamber 38 and includes a ball holder 52 on an uphole end 54 of the sleeve 48. The second spring 50 engages a shoulder 56 on the ball holder 52 (i.e., the ball holder 52 is wider than the sleeve 48 extending from the ball holder 52) on one end and engages a set screw 58 that can be threaded in a downhole portion 60 of the lower spring chamber 38. The sleeve 48 that extends from the ball holder 52 extends down into the second spring 50.

The ball holder 52 can have radial directed openings 62 disposed therein that are in fluid communication with the portion of the sleeve 48 extending from the ball holder 52. The radial directed openings 62 in the ball holder 52 permit fluid entering the lower spring chamber 38 to pass through the sleeve 48 and out of the outlet 46 of the adjustable check valve 10. The ball holder 52 also includes a ball 64 disposed partially therein that the second spring 50 forces to engage the second seat 42 on the uphole end 44 of the lower fluid chamber 38 to prevent fluid from passing uphole through the adjustable check valve 10. The forced engagement of the ball 64 on the second seat 42 also prevents fluid from passing through the adjustable check valve 10 in the downhole direction unless the pressure of the fluid in the adjustable check valve 10 is above a certain pressure. When the fluid gets above a certain pressure (cracking pressure), the second spring 50 collapses as the ball is forced away from the second seat 42, which permits fluid to flow from the second passageway 36 to the lower fluid chamber 38. The fluid can enter an upper area 66 of the lower spring chamber 38 wherein the fluid can pass into and through the radial directed openings 62 in the ball holder 52, through the sleeve 48, into a lower area 68 of the lower spring chamber 38 and out the outlet 46 of the adjustable check valve 10.

The set screw 58 can be threaded into the lower part 68 of the lower spring chamber 38 to engage a downhole end 70 of the second spring 50 and squeeze the spring 50 between the set screw 58 and the shoulder 56 on the ball holder 56. The set screw 58 can be threaded into the lower part 68 of the lower spring chamber 38 any desired amount such that the desired tension is placed on the second spring 50. The more the set screw 58 is threaded towards the second spring 50, the more tension is placed on the second spring 50. The cracking pressure of the adjustable check valve 10 increases as the tension on the second spring 50 increases. In another embodiment, a locking screw 72 can be threaded on the downhole side 74 of the set screw 58 to lock the set screw 58 in place. The set screw 58 and the locking screw 72 can have openings 76 disposed therethrough to permit fluid to flow downhole through the adjustable check valve 10.

The present disclosure is also directed to a method of setting the crack pressure of the adjustable check valve 10. The parts of the adjustable check valve 10 can be assembled to cause the adjustable check valve 10 to have the desired crack pressure. The set screw 58 can be threaded into the lower part 68 of the lower spring chamber 38 to provide the desired amount of tension for the second spring 50 such that the desired cracking pressure of the adjustable check valve 10 is achieved. The locking screw 72 can then be threaded into the lower part 68 of the lower spring chamber 38 tightly against the set screw 58 to lock the set screw 58 in place and prevent the set screw 50 from coming loose so that the desired crack pressure of the adjustable check valve 10 is maintained.

From the above description, it is clear that the present disclosure is well-adapted to carry out the objectives and to attain the advantages mentioned herein as well as those inherent in the disclosure. While presently preferred embodiments have been described herein, it will be understood that numerous changes may be made which will readily suggest themselves to those skilled in the art and which are accomplished within the spirit of the disclosure and claims.

What is claimed is:

1. An adjustable check valve, the adjustable check valve comprising:
a housing with an inlet and an outlet;
a sleeve slidably disposed in the housing, the sleeve having a ball holder portion with a first ball disposed therein;
a first spring disposed in a lower spring chamber that engages the sleeve to force the first ball into a first seat to prevent fluid from flowing uphole in the adjustable check valve; and
a set screw threadably engaged with the housing to apply a desired amount of tension to the first spring.

2. The adjustable check valve of claim 1 further comprising a locking screw to secure the set screw in position to apply the desired amount of tension to the first spring.

3. The adjustable check valve of claim 1 further comprising a second spring disposed in an upper spring chamber wherein the second spring forcing a second ball into a second seat in the upper spring chamber.

4. The adjustable check valve of claim 3 further comprising a passageway that fluidically connects the upper spring chamber and lower spring chamber.

5. The adjustable check valve of claim 1 wherein the ball holder portion of the sleeve includes a radial directed opening disposed therein.

6. The adjustable check valve of claim 1 wherein a portion of the sleeve is disposed within the first spring.

7. The adjustable check valve of claim 3 wherein the second spring is conical shaped.

8. The adjustable check valve of claim 4 wherein the first ball prevents fluid from flowing uphole through the passageway.

9. The adjustable check valve of claim 3 wherein the second spring and the second ball prevents fluid from flowing uphole and out of the adjustable check valve.

10. The adjustable check valve of claim 2 wherein the set screw and locking screw can be threaded into the lower spring housing of the adjustable check valve.

11. A method of designing an adjustable check valve to have a desired crack pressure, the method comprising:
determining a desired crack pressure of the adjustable check valve based on operational parameters; and
assembling the adjustable check valve to have the desired crack pressure.

12. The method of claim 11 wherein the adjustable check valve comprises:
a housing with an inlet and an outlet;
a sleeve slidably disposed in the housing, the sleeve having a ball holder portion with a first ball disposed therein;
a first spring disposed in a lower spring chamber that engages the sleeve to force the first ball into a first seat to prevent fluid from flowing uphole in the adjustable check valve; and
a set screw threadably engaged with the housing to apply a desired amount of tension to the first spring.

13. The method of claim 12 wherein the adjustable check valve further comprises a locking screw to secure the set screw in position to apply the desired amount of tension to the first spring.

14. The method of claim 12 wherein the adjustable check valve further comprises a second spring disposed in an upper spring chamber wherein the second spring forcing a second ball into a second seat in the upper spring chamber.

15. The method of claim 14 wherein the adjustable check valve further comprises a passageway that fluidically connects the upper spring chamber and lower spring chamber.

16. The method of claim 12 wherein the ball holder portion of the sleeve includes a radial directed opening disposed therein.

17. The method of claim 12 wherein a portion of the sleeve is disposed within the first spring.

18. The method of claim 14 wherein the second spring is conical shaped.

19. The method of claim 15 wherein the first ball prevents fluid from flowing uphole through the passageway.

20. The method of claim 13 wherein the set screw and locking screw can be threaded into the lower spring housing of the adjustable check valve.
